(19) United States
(12) Patent Application Publication
(10) Pub. No.: US 2009/0030910 A1
(43) Pub. Date: Jan. 29, 2009

(54) Information storage and management system and method for automating online requests and transactions

(76) Inventors: Stephen Bennett, Fenstanton (GB); Angus Jones, Melbourne, FL (US)

Correspondence Address: HAYWORTH, CHANEY & THOMAS, P.A., 202 N. HARBOR CITY BLVD., SUITE 300, MELBOURNE, FL, 32935, US

(21) Appl. No.: 11/881,117

(22) Filed: Jul. 25, 2007

(51) Int. Cl. G06F 17/30

(52) U.S. Cl. 707/10

(57) ABSTRACT

A relational database system and method for electronically storing and managing data, documents, and files relating to individuals, properties, vehicles, pets, assets, corporate bodies, and the like, to facilitate easy viewing, retrieval, organization and onward transmission of such information. The system enables a user to enter information into the intuitive relational database system on a once-only basis. The system integrates seamlessly on a user selectable two-way basis with third party suppliers, agencies, and computer programs. The system and method allow for centralized storage and then automated communication of a user's information for the purposes of receiving notifications of the lowest service provider quotes as well as sending notifications of emergency response, moving information, address updates, disaster recovery, and the like, from a single relational database system. Acceptance of such quotes may be automatic, and relevant documentation may thereafter be uploaded to the user's account for later search and review.

### CROSS REFERENCE TO RELATED APPLICATIONS

Not applicable.

### STATEMENT REGARDING FEDERALLY SPONSORED RESEARCH OR DEVELOPMENT

Not applicable.

### INCORPORATION-BY-REFERENCE OF MATERIAL SUBMITTED ON A COMPACT DISK

Not applicable.

### BACKGROUND OF THE INVENTION

1. Field of the Invention

The invention generally relates to the field of systems and methods for automating online requests and transactions utilizing stored personal information.

2. Background Art

With the recent popularization of the Internet, various pieces of information have come to be available. When such information is utilized, a user may solicit product and service quotations, purchase products and services, and the like.

For example, when accessing a predetermined service or information provider through the Internet to purchase a predetermined service or product through the home page of that service or information provider, a user must input personal information such as his or her name, age, address, telephone number, and credit card number to submit these pieces of information to the provider. When accessing two or more service or information providers to acquire plural products, the user must submit his or her personal information to each of these providers every time he or she places an order. Usually, the personal information to be submitted to these providers is substantially the same in content. Therefore, the user needs to input the same information repeatedly, a time-wasting and error-prone operation.

Entities that do businesses on the Internet frequently request web site visitors fill out forms containing demographic and other information or data. Web sites such as the New York Times web site that provide free access to news, sites such as the Adobe Corporation web site that provide free downloadable software, sites that provide free magazine subscriptions, sites that provide free or paid services such as a free e-mail account, free Internet access, and similar others, are just a few well known examples. In some cases the forms are so lengthy that repeated requests for such information can cause an annoyance to a user. The providers of these forms, however, would like to have as much information about the user as possible so that they could obtain a profile of the type of persons that are interested in their products or services. Typically such web sites may include some limited form of auto-fill capability from information stored on the user's local computer. It would be useful to all the users and providers if the users could store all of their information on an encrypted centralized intuitive database and authorize the release of such information to any person or entity for the purpose of requesting quotes and services across a plurality of service provider fields.

Some other examples of entities that request such personal information include credit verification agencies acting on behalf of lenders, utility companies, landlords and the like; and information gathering entities such as health insurance companies, doctor's offices, consumer or product surveys, and magazine subscriptions.

With the ubiquity of the public computer communication networks, commonly known as the Internet or the web, a new way of disseminating personal information has become possible. The meteoric rise of the Internet has enabled it to become a key application development platform. Notwithstanding the availability of these communication networks, there is currently no method whereby a user can enter and store his personal information at a single location on a once only basis and selectively authorize it to be distributed to a number of entities across a plurality of service provider fields. When accessing two or more service or information providers to acquire plural products, the user must submit his or her personal information to each of these providers every time he or she places an order. Usually, the personal information to be submitted to these providers is substantially the same in content. There is a need for the present inventive system and method to eliminate user input of repetitive information.

Additionally, there are no current systems or methods whereby the user can update or make changes to the personal information stored at the single location—whether it is a single server computer or a collection of server computers comprising a distributed system—and cause the changes to be distributed to all persons or entities that need to be notified. Accordingly, there is a need for such a system and method.

Further, there is a need for a system and method which allows a user to manage all of their account administration needs from a centralized system, without the need for researching multiple comparison web sites for each account, policy, utility or insurance plan being managed in respective service provider fields.

A still further need exists for a system and method allowing a user to easily manage their administrative needs, as well as being able to manage the administrative needs of others, such as dependent minors and elderly family members.

Old methods of collecting and disbursing personal information required service providers such as credit reporting agencies to gather and disburse information about individuals and companies, and to disburse this information to entities that request such information. In general, such disbursement is performed after an individual authorizes the release of such information. When such credit reporting companies gather credit information, they often provide incomplete or inaccurate information that is not verified by the user until a later date. These problems with the existing systems and methods for storing and communicating personal information can be alleviated by the present invention as described in the following.

### BRIEF SUMMARY OF THE INVENTION

The invention is directed to both a system and method for storing and transacting personal information of a user for the purpose of managing such information and obtaining the lowest possible quotes for products or services.

The present invention is directed toward a system for storing and transacting personal information of a user comprising a communication network, a server computer comprising a database for storing the personal information from a plurality of users including the user wherein the server computer and the database are communicatively coupled to the communication network, a user computer communicatively coupled to the communication network providing communication between the user computer and the server computer, wherein the personal information is inputted and communicated on a once-only basis into the database to eliminate input repetition of the personal information, and a plurality of service provider computers communicatively coupled to the communication network providing selective communication between the plurality of service provider computers and the database, wherein the server computer queries the plurality of service provider computers for service provider quotes, wherein a lowest possible quote is automatically determined by comparing the quotes received from the plurality of service provider computers.

The present invention is also directed toward a method of storing and transacting personal information of a user comprising the steps of communicating the personal information from a user computer to a database of a server computer on a once-only basis to eliminate input repetition of the personal information, wherein the user computer and the server computer are communicatively coupled over a communication network, storing the personal information on the database of the server computer, selectively transmitting the personal information from the database to a plurality of service provider computers communicatively coupled to the communication network, wherein the system queries for service provider quotes from the plurality of service provider computers, and receiving the quotes from the plurality of service provider computers to the server computer, wherein a lowest possible quote is automatically determined by comparing the quotes received from the plurality of service provider computers.

It is an aspect of the present invention to overcome the drawbacks associated with users having to either repeatedly input identical user information into fields on numerous comparison web sites or perform the arduous administrative task of researching individual service provider web sites to compare and determine the best rates and/or plans for the user.

It is another aspect of the present invention that all of a user's accounts may be stored and protected on one intuitive database; saving time, money and stress associated with having multiple accounts spread across a variety of locations. All of a user's accounts and records are organized in one place and the user may then access and manage their administrative duties from any available communication network connection. The present invention may then automatically and routinely optimize all of the user's accounts and policies, as compared to current technology that only provides for instant comparisons within one specific service provider field.

It is a further aspect of the present invention that the intuitive database may find and add relevant personal information or verify already inputted personal information by means of accessing third party information sources, such as governmental agencies and financial institutions.

Still another aspect of the present invention is an automated system for saving user money by searching hundreds of suppliers for the best rates and/or policies regarding accounts centrally stored within a user's profile. System search comparisons may be performed instantaneously upon a user's request, at any preset customized periodic interval, upon the approach of an account/policy deadline or renewal date, or any combination thereof.

Still yet another aspect of the present invention is the enablement of customizable reminders provided to the user via numerous methods including but not limited to user specific home page notifications, standard emails, and SMS message service.

Further, any modifications, updates, or changes may be automatically communicated to listed service providers of a user. Such automated updating facilitates stressful periods, such as address changes during a move or cancelling lost credit cards after a theft or other catastrophic event.

### BRIEF DESCRIPTION OF THE DRAWINGS

FIG. 1 depicts a schematic block diagram of an embodiment of the system of the present invention.

FIG. 2 depicts a schematic block diagram of an embodiment of various service provider queries by the system of the present invention

FIG. 3 depicts an embodiment of personal information stored within the system of the present invention.

FIG. 4 depicts people file data stored within the system of the present invention, and examples of downloading and uploading the information.

FIG. 5 depicts property file data stored within the system of the present invention, and examples of downloading and uploading the information.

FIG. 6 depicts vehicle file data stored within the system of the present invention, and examples of downloading and uploading the information.

FIG. 7 depicts pet file data stored within the system of the present invention, and examples of downloading and uploading the information.

FIG. 8 depicts a process flow diagram of an embodiment of a method of requesting an instantaneous quote for a specific user file.

### DETAILED DESCRIPTION OF THE INVENTION

In the figures, like reference numerals denote like parts or steps.

The term “personal information” is to be broadly defined and may include, but is not limited to, information such as name, age, address, email, social security number, household information, and the like. Within the scope of the present invention, the term “personal information” may further include but is not limited to information pertaining to individual persons, legal entities (e.g. companies, corporations, etc.), organizations, associations, clubs, and the like.

The terms “service provider” and “service provider fields” are to be broadly defined and may include any known administrative fields and respective providers pertaining, but not limited to, driver licenses, passports, bank accounts, savings accounts, credit cards, store cards, loyalty cards, social security accounts, retirement accounts, pensions, memberships, subscriptions passwords, domain name registrations, cellular phone contracts, travel insurance, breakdown coverage, key dates (e.g. anniversaries, birthdays, etc.), life insurance, health policies, wills and trusts, medical records, prescription information, mortgages, mortgage insurance, appliance warranties, electric bills, telephone bills, water and sewage bills, insurance, broadband bills, natural gas bills, satellite bills, service agreements, supplier contracts, asset registers, home security/alarm details, garage door codes, vehicle warranties, car insurance, vehicle tax, vehicle registration, vehicle service details, vehicle tracking details, radio unlock codes, vehicle information summaries, satellite navigation details, veterinary records, pet passports, annual inoculations, pet medications, pet insurance, ID chip details, veterinary business details, pet birth records, and the like.

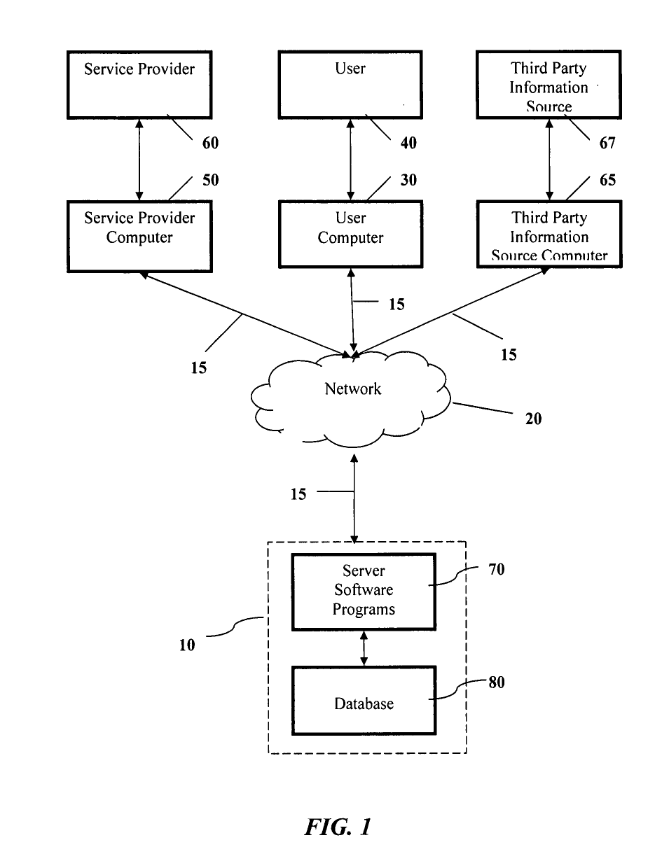

Referring to FIG. 1, a server computer 10 configured in accordance with the principles of the present invention is communicatively coupled 15 to a communication network 20 such as the Internet. Also communicatively coupled 15 to the communication network 20 is a user computer 30 operated by a user 40, a service provider computer 50 operated by a service provider 60, and a third party information source computer 65 operated by a third party information source 67.

The server computer 10 may illustratively comprise a microprocessor, a disk drive, a memory such as a semiconductor memory, and runs an operating system such as Windows-NT™ or Linux. The server computer 10 communicative connection 15 to the network 20 may be established via the means well known in the art for connecting computers to a communication network such as the internet, including via an Internet Service Provider (ISP), a direct connection, a connection through another server, a connection via a Local Area Network, or the like. The communicative connection 15 may include, but is not limited to, a radio communications port of the type commonly used in personal computers such as that defined in Institute of Electrical and Electronic Engineers (IEEE) specification 802.11 commonly known as WiFi, an Ethernet interface port, a standard computer serial interface port, a standard computer parallel interface port, a firewire port, an infrared port, or a USB interface port. In a preferred embodiment, the server computer 10 is connected 15 to the communication network 20 via a high-speed connection such as a Digital Subscriber Line (DSL) or cable modem. The communicative connections 15 for the service provider computer 50 and the third party information source computer 65 may respectively comprise the same modality as the connection for the user computer 30, or any equivalent or combination thereof.

The server computer 10 is configured to function as a web server. A web server is typically a general purpose computer running various server software programs 70, which may include software to interface with the Internet using sockets and software for interfacing external software with an informational database 80. Database 80 may reside on the server computer 10 as shown in FIG. 1, or may reside on an external computer or computer media. Such server software programs 70 can be obtained from a variety of sources known within the art. Interfacing programs such as Common Gateway Interface (CGI) programs may reside on the server computer 10. The CGI programs provide for communication and interaction between a user computer 30 and the server computer 10 via the communication network 20. These server software programs 70, CGI programs coupled with data communications software programs, are configured to receive packets of messages from computers connected to the communication network 20, understand the information in the packets, and act according to instructions provided in the packets within the constraints imposed by an administrator managing the server computer 10.

In addition to performing the tasks of receiving and sending packets of data to and from the computers connected to the Internet, the CGI programs are configured to perform other tasks such as communicate with an informational database 80, and extract or store information in the database 80 according to the software instructions provided within the server computer 10 or in the packets received from the communication network 20. Persons skilled in the art may program these CGI programs using programming tools and languages such as or equivalent to C, C++, Java, Perl and Shell scripts.

The server computer 10 may be configured to receive request messages from the user computer 30 over the communication network 20 in the Hyper Text Transfer Protocol (HTTP), File Transfer Protocol (FTP) or any similar protocol used to transfer data, video, voice or any combination of these media. After analyzing the request messages, the server computer 10 is configured to transmit in response messages that include “web pages” that are programmed in Hyper Text Markup Language (HTML) or a similar language.

Embedded in these web pages are components such as documents, scripts, and objects that are configured to display colorful graphical images on a display device coupled to the user computer 30. Persons skilled in the art know how to make web pages using programming languages or tools such as HTML, Cold Fusion™, Java®, Java Script™, Active Server Pages™, Dynamic HTML, the various markup languages such as Extensible Markup Language (XML), and other similar tools known within the art.

In one embodiment, the user computer 30 is a digital interactive device such as a personal computer comprising a microprocessor, a display device such as a flat panel display or a CRT, a memory such as semiconductor memory, a storage device such as a hard drive, an input device such as a keyboard, and a pointing device such as a mouse. In other embodiments, there could be provided a microphone or other speech input device and a voice or speech recognizer coupled to the user computer 30, whereupon a user 40 could provide input to the user computer 30 using spoken word commands. In the following, the word “selection” includes clicking a mouse or other pointing device coupled to the user computer 30 at least once; typing at least one character on a keyboard; allowing for a timer to expire; speaking at least one voice command into a microphone coupled to the user computer 30; or touching at least one area on a touch-sensitive screen, and other equivalent methods. The user computer 30 is equipped with suitable devices and programs to connect to the communication network 20.

In alternative embodiments, the user computer 30 is another device capable of establishing a communication in conjunction with other similar or dissimilar devices over a communication network 20 such as the Internet. Examples of other commercially available digital interactive devices that are contemplated within the scope of the present invention to function in place of the user computer 30 include but are not limited to a telephone, a WebTV™ device marketed by Microsoft Corporation of Redmond, Wash., a Palm Pilot™ device marketed by 3-COM Corporation of Santa Clara, Calif., or other similar device; the device used in conjunction with the Wireless Web™ service from the Sprint Corporation of Westwood, Kans.; or a Wireless Access Protocol (WAP)-enabled device such as the device marketed by @Motion.com used in conjunction with Wireless Internet service provided by companies such as Phone.com and supported by protocols such as Wireless Markup Language, Mobile Phone Markup Language. Such compatible wireless handset devices are manufactured by Nokia, Motorola, Ericsson, and other companies.

In the embodiments described below, a user 40 can navigate the communication network 20 using either graphical or text-based navigational software. Additionally, in a preferred embodiment, the user computer 30 is configured to navigate the communication network 20 via a browser such as Internet Explorer™ marketed by Microsoft Corporation of Redmond, Wash. Additionally, Opera™ is a browser configured to enable viewing XML documents and is available at www.opera.com. Other browsers such as virtual reality browsers can be used to obtain a three-dimensional experience of the communication network 20. An example of a text-based browser can be found in the software program Lynx, which is available free of charge.

The service provider computer 50 and third party information source computer 65 may also comprise a microprocessor, a memory such as semiconductor memory, a storage device such as a hard drive, a display device such as a CRT or an LCD display, and a communications interface device such as a network card to enable connection to the communication network 20 either directly or via an ISP. The service provider computer 50 may incorporate additional software such as a handshake protocol to ensure safe delivery of information objects.

In a preferred embodiment, the invention described herein is implemented principally on the server computer 10 and the user 40 interacts with the server computer 10 via a browser program executing on the user computer 30. Similarly, the service provider 60 also interacts with the server computer 10 via the service provider computer 50 and the third party information source 67 interacts with the server computer 10 via the third party information source computer 65.

In use as depicted in FIG. 1, a user 40 may input their personal information into the database 80 of a server computer 10 via a communicative connection 15 to a network 20. In this manner, a plurality of users may input and save their respective personal information in the database 80 on a once-only basis to eliminate input repetition of personal information. A user's personal data may then be selectively transmitted to a service provider 60 via a communication network 20, a communicative connection 15, and a service provider computer 50. In such a manner, the system utilizes the transmitted personal information to query a plurality of service provider computers 50 for service provider quotes. The server computer 10 receives the quotes from the plurality of service provider computers 50 and compares the quotes to determine the lowest possible quote for the user 40. The system then communicates the lowest possible quote to the user 40, and the user 40 may either accept or reject the service provider 60 quote. If the quote is accepted, the system may link the user to the service provider computer 50 via the communication network 20 and auto-populate the relevant personal information fields.

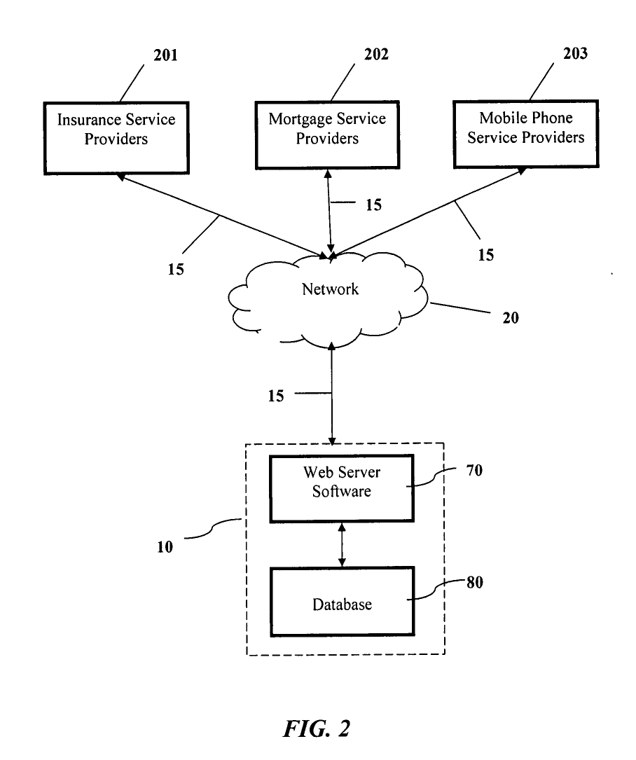

The scope of the present invention includes the system's ability to query for a lowest possible quote within a specific service provider field that is part of a plurality of respective service provider fields. FIG. 2 depicts the system of the present invention querying for a lowest possible quote from one of at least three service provider fields, which may include but are not limited to insurance service providers 201, mortgage service providers 202, or mobile phone service providers 203, respectively. The system may also query for a plurality of respective lowest possible quotes across a plurality of respective service provider fields (e.g. 201, 202, and 203). In this manner a user 40 will not have to continually visit a different quote comparison web site for each respective service provider field. The system of the present invention enables the user 40 to receive the lowest possible quote from each respective service provider field.

The system of the present invention may be configured to automatically query a plurality of service providers 60 for quotes in a variety of means. A request by a user 40 may trigger the system to instantaneously query a plurality of service providers 60 for quotes when an immediate quote is desired. Also, a user 40 may configure the system of the present invention to automatically query a plurality of service providers 60 for service provider quotes on a recurring periodic basis (e.g. weekly, monthly, annually, and the like). Yet further, the user 40 may configure the system of the present invention to automatically query a plurality of service providers 60 for service provider quotes at a preset specified time period prior to a user's account renewal or expiration dates. In this way, a user 40 may be notified of any better options that are available when the user is able to renew or transfer their choice of service providers 60.

Additionally, the system of the present invention may further allow the user 40 to customize and/or preset the criteria for the requested quotes. A first option may enable the user 40 to request quotes on a “like for like” basis and thereby receive quotes that match the criteria or terms of the present or last known service or policy. As an example, requested quotes may be preset to receive auto insurance premiums for identical levels of coverage (i.e. chosen coverage plans, equivalent deductibles, etc.). This allows for a direct and relevant comparison of service provider quotes without requiring either the system or user 40 to locate distinctions within the respective policies or terms that may affect the quote price. Other options may allow the user 40 to increase or decrease specific terms or policies when presetting the criteria of the quote requests. As an example, a preset quote request for auto insurance may query for quotes having either an increase or decrease relative to the user's current deductible.

The selective communication between the server computer 10 and the plurality of service provider computers 50 allows for ease of updating a user's personal information. For example, when a user 40 moves to a new primary residence the user 40 may utilize the system of the present invention to send notifications to the relevant service providers 60. As an alternative, the system may print update notifications (e.g. address change) for the user 40 to sign and then forward along to the service providers 60 as may be required.

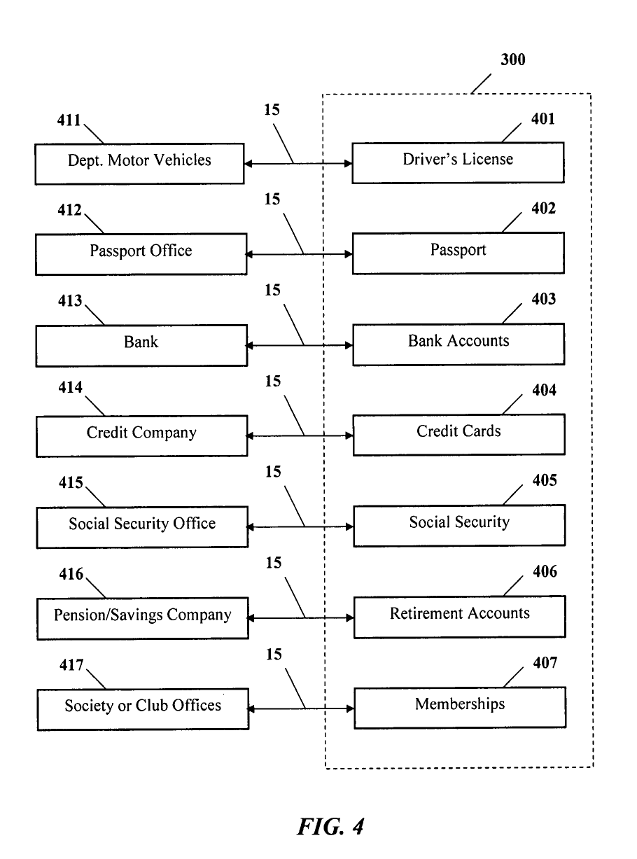

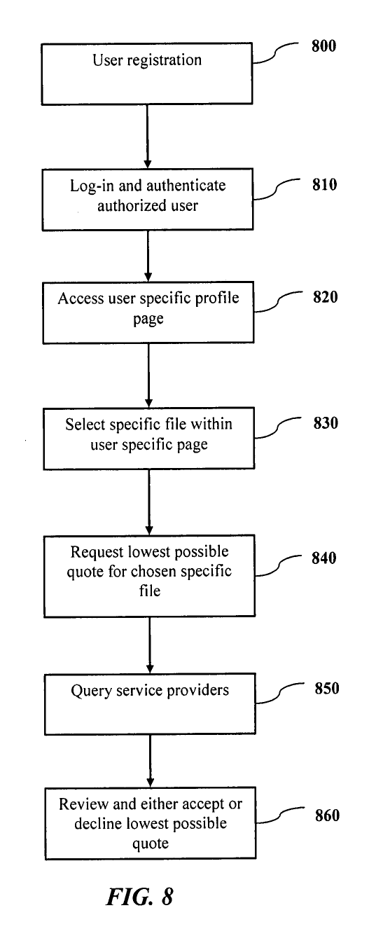

The system provides further functionality in addition to requesting service provider quotes and easily updating personal information across all pertinent service providers 60. To ease the user burden during the registration phase (see FIG. 8) and any other instances of required user data input, the system may communicate 15 with third party information source computers 65 to acquire a user's personal information and auto-populate the relevant data fields within the database 80. For example, if a user indicates they own a vehicle, the system may automatically communicate with the appropriate Department of Motor Vehicles for the user's personal information and auto-populate user data fields such as vehicle make, model, VIN number, and other vehicle registration information. Possible third party information sources 67 are depicted in FIGS. 4-7 and may include but are not limited to the Departments of Motor Vehicles 411,614, passport offices 412,712, banks 413, credit companies 414, social security offices 415, pension/savings companies 416, society or club offices 417, mortgage lenders 511, appliance manufacturers 512, electricity providers 513, telephone providers 514, water and sewage providers 515, insurance providers 516,612,715, broadband providers 517, vehicle manufacturers 611, county appraisers 613, vehicle repair providers 615, security providers 616,716, product manufacturers 617, veterinary providers 711,713,714, and the like.

Additionally, the system may communicate 15 with third party information source computers 65 to verify already inputted personal information, as opposed to locating and adding such personal information to the database 80. In this manner, possible user input error and unknown account changes may be easily identified and automatically corrected by the system.

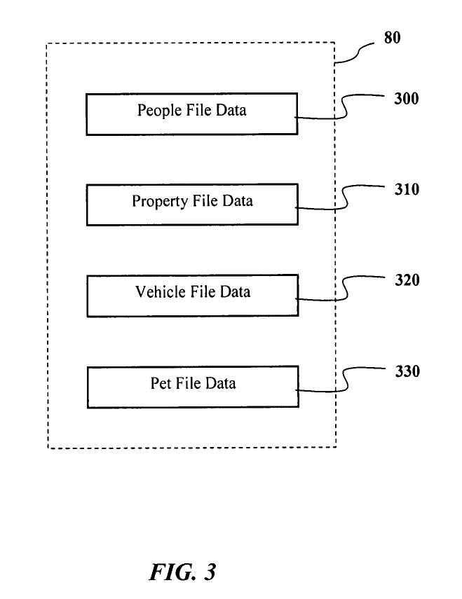

As shown in FIG. 3, the informational database 80 may comprise groups of data including people file data 300, property file data 310, vehicle file data 320, pet file data 330, and the like. These types of file data are given for illustration purposes only and one or more such groupings or different groupings may be used. One alternative embodiment of data grouping style may include category-type groups, such as product file data groups and insurance file data groups. The method of organization of the data files may include any convenient known method of organizing the data. Thus each user 40 is capable of uniquely organizing and managing their data files in any manner they see fit, as is possible with any traditional paper filing cabinet.

The people file data 300 is shown in greater detail in FIG. 4, which depicts examples of the types of people file data 401-407 that may be stored, such as information pertaining to a user's driver license 401. This data may be obtained directly from user 40 inputs or from respective third party information sources 411-417 and the data may thereafter be used to obtain quotes and products or services from service providers 60 in a manner as described.

People file data 300 may include files relevant to service and/or product information including, but not limited to, a user's driver license 401, passport 402, bank accounts 403, credit cards 404, social security 405, retirement accounts 406, memberships 407, subscriptions passwords, domain name registrations, cellular phone contracts, travel insurance, breakdown coverage, pensions, credit cards, store cards, loyalty cards, key dates (e.g. anniversaries, birthdays, etc.), savings accounts, life insurance, health policies, wills and trusts, medical records, prescription information, and the like.

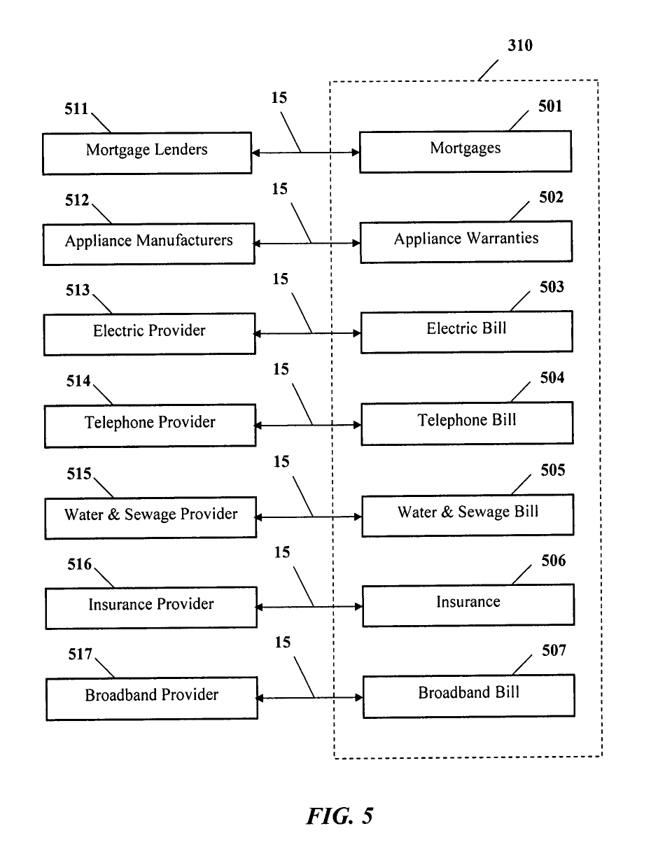

The property file data 310 is shown in greater detail in FIG. 5, which depicts examples of types of property file data 501-507 that may be stored, such as information pertaining to a user's mortgages 501. This data may be obtained directly from user 40 inputs or from the respective third party information sources 511-517 and the data may thereafter be used to obtain quotes and products or services from service providers 60 in a manner as described.

Property file data 310 may include files relevant to service and/or product information including, but not limited to, a user's mortgages 501, mortgage insurance, appliance warranties 502, electric bill 503, telephone bill 504, water and sewage bills 505, insurance 506, broadband bill 507, natural gas bill, satellite bill, service agreements, supplier contracts, asset registers, home security/alarm details, garage door codes, and the like.

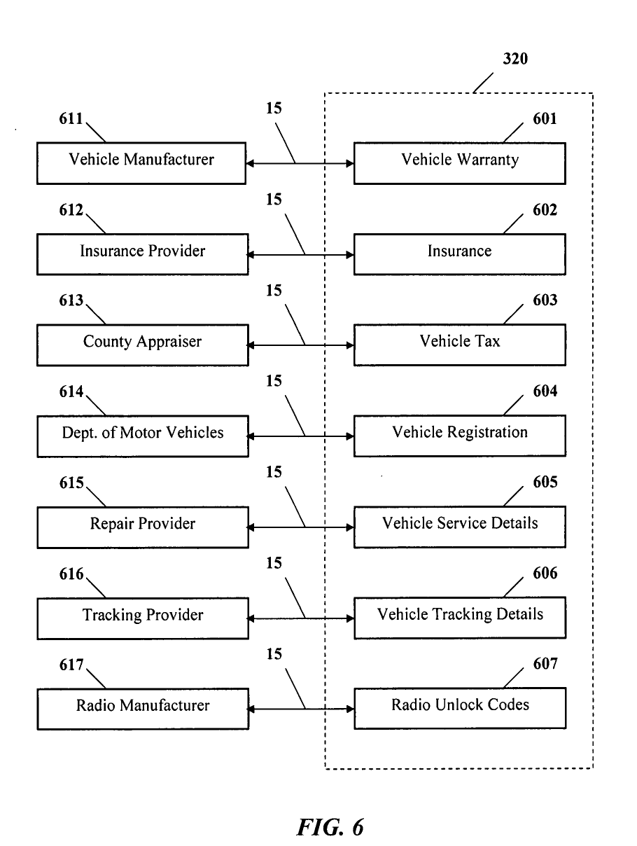

The vehicle file data 320 is shown in greater detail in FIG. 6, which depicts examples of the types of vehicle file data 601-607 that may be stored, such as information pertaining to a user's vehicle warranty 601. This data may be obtained directly from user 40 inputs or from the respective third party information sources 611-617 and the data may thereafter be used to obtain quotes and products or services from service providers 60 in a manner as described.

Vehicle file data 320 may include files relevant to service and/or product information including, but not limited to, a user's vehicle warranties 601, car insurance 602, vehicle tax 603, vehicle registration 604, vehicle service details 605, vehicle tracking details 606, radio unlock codes 607, vehicle information summary, satellite navigation details, and the like.

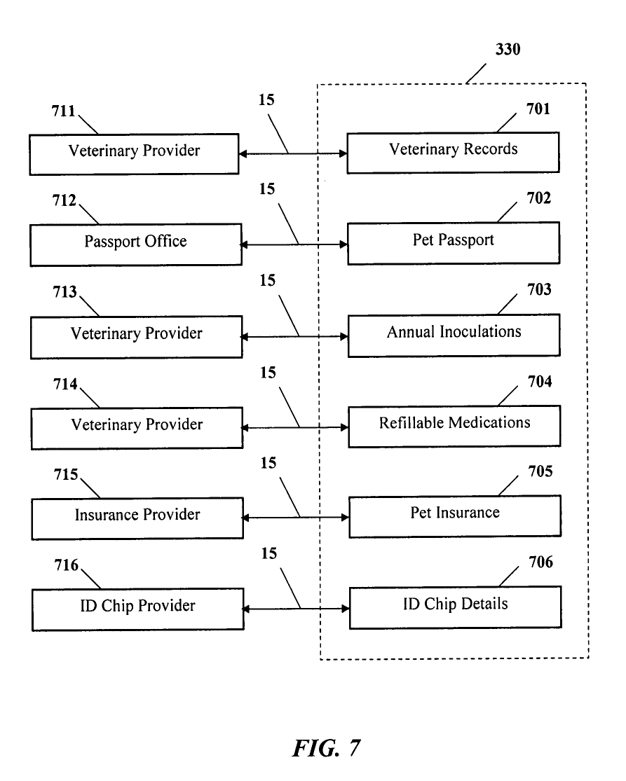

The pet file data 330 is shown in greater detail in FIG. 7, which depicts examples of the types of pet file data 701-706 that may be stored, such as information pertaining to a pet's veterinary records 701. This data may be obtained directly from user 40 inputs or from the respective third party information sources 711-716 and the data may thereafter be used to obtain quotes and products or services from service providers 60 in a manner as described.

Pet file data 330 may include files relevant to service and/or product information including, but not limited to, veterinary records 701, pet passport 702, annual inoculations 703, pet medications 704, pet insurance 705, ID chip details 706, veterinary business details, pet birth records, and the like.

FIG. 8 depicts steps that may be included in an embodiment of the current inventive method. During a registration step 800, a user specific web page may be established for each user 40. After registration 800, the user 40 may be required to perform a log-in authentication step 810 prior to being able to access 820 the user specific web page. The user specific web page may comprise personal data files stored on an informational database 80 of a server computer 10 that is coupled either directly to the Internet or accessible via the Internet or other communication network 20. The server computer 10 and database 80 are capable of manually or automatically retrieving or verifying personal information stored on third party information source computers 65. Within the user specific web page, the user 40 may select 830 a specific personal information file to review or manage. Personal information files may include, for example, a credit card file or an auto insurance file. The user 40 may then request 840 the system to find the lowest quote possible for the selected file (e.g. lowest credit card interest rate or lowest auto insurance premium, respectively). The system then queries 850 relevant service provider computers 50 to receive relevant service provider quotes currently available. The quotes may be reviewed 860 by the user 40 and thereafter may either be accepted or declined. The review step 860 may occur either instantaneously or within the period for which the quote remains valid (e.g. within 30 days for most industries providing such quotes).

Upon the act of accepting a quote, the functionality of the system of the present invention may provide a link through which the user 40 may manually complete the transaction with the chosen service provider 60. As a preferred alternative, upon acceptance of a quote by the user 40 the system of the present invention may be preset to automatically complete the transaction with the chosen service provider 60. With the transaction completed, the service provider 60 may upload any and all relevant documents (e.g. invoices, policies, warranties, etc.) into the proper service provider data file within the user's account. The user 40 may thereafter be able to easily locate, review and word search all uploaded documents (e.g. insurance policies) via any available internet-enabled computing device. Such allowance for the uploading of digital documents greatly increases the speed of the document delivery process and significantly reduces the amount of paper commonly used for hand delivery of such documents.

The step for requesting 840 the lowest possible quote for a specific file may be initiated in a variety of ways. As described above, the user 40 may enter 820 the user specific web page on the system and manually request 840 an instantaneous search for a lowest possible quote. Additionally, the user 40 may configure their user specific web page to request 840 and automatically perform 850 quote searches at regularly scheduled intervals (e.g. weekly, monthly, quarterly, annually, etc.) to ensure the administrative costs for the user's respective accounts are managed and maintained at a minimal cost. Yet further, the user 40 may configure their user specific web page to request 840 and automatically perform 850 quote searches at preset specific time periods (e.g. 30 days before a service provider account expires or comes up for renewal) to ensure that the user 40 is notified of available better quotes and offers before a current account may either terminate or automatically renew. The ability to uniquely configure and then automatically set search and review parameters relevant to rates and quotes of a user's administrative accounts is indispensable. By setting up 800 a user specific account on the system, a user 40 may thereafter be spared the time consuming task of hunting hundreds of independent web sites for lower interest credit cards, cheaper cell phone plans, and lower insurance premiums. The user 40 may establish customized review periods for their respective accounts so that their administrative account review is set on auto-pilot and the user 40 simply receives notifications whenever a more beneficial quote, plan or offer is available. A user's time can then be spent enjoying life, rather than managing it.

The system and method of the present invention allows a user 40 to manage all of their administrative accounts stored on the informational database 80 of the server computer 10 from their user specific web page. Competing web sites may perform comparisons on quotes, rates or offers in one specific field of service providers (e.g. auto insurance), but the present invention provides for the requesting and customizable performance of optimizing comparisons across all fields of service providers 60. The present invention saves users both time and money by automatically searching hundreds of service providers as user policies come up for renewal, as suppliers increase their prices, or as special offers are launched. Such automation of user administrative duties further allows a user to review and manage the administrative duties of other individuals, such as minor children or elderly family members.

Having registered 800 with the system of the present invention, it is necessary to populate the relevant data files on the database 80 that are to be stored, managed and protected. This may be conveniently performed using the communication network 20 connection to access a relevant third party information source 67 and download user data after suitable authentication, see FIGS. 4-7. Alternatively, the user 40 may manually input their data and use the communication network 20 connection to compare and verify the user inputted data to that of the respective third party information source computers 67. For example, referring to FIG. 4, data (e.g. balance, credit limit, and interest rate) stored on a credit company computer 414 may be transferred and saved as user credit card data 404 on the database 80 of the present invention. Alternatively, information manually inputted by the user 40 may be verified against the information stored on the credit company computer 414. User credit card data 404, such as the interest rate, may then be compared via the communication network 20 to interest rates available from a plurality of service providers 60 (see FIG. 1).

The selective communication between the database 80 of the present invention and the plurality of service provider computers 50 across a plurality of respective service provider fields allows for many benefits. As described above, the system and method of the present invention allow for an efficient means to manage, transact, and update all personal information of a user 40. Additionally, the present invention may further alert and notify all relevant service providers 60 when a user 40 relocates to a new address. The present invention supports a user's relocation by automating the updating, cancellations and/or transfers of all their policies, agreements, supplier contact details and documentation to make sure everyone is aware of the new address information. The system may further mail merge stored personal data files with standard template letters for each specific set of change of address instructions. Such designated letters with supplier addresses, policy numbers, specific instructions and forwarding addresses may then be printed out to be signed at the user's convenience. Updating in such a manner saves a user 40 hours, if not days, of calling suppliers and service providers regarding a home move.

Similarly, a disaster recovery feature may be readily available over the system of the present invention. A user 40 may add or remove service provider files from a specialized disaster recovery folder. Following an unfortunate occurrence such as a fire or theft, the user 40 may activate the disaster recovery process and all service providers will be notified and new cards, policy copies, etc. will automatically be requested. With the database 80 being centrally located and in communication with a network 20 such as the Internet, the user 40 will be able to initiate the disaster recovery process from any available network 20 connection.

During user registration 800, the user sign-up process should be stream-lined to be as quick as possible for a user 40. Preferably, a user 40 may be able to register 800 with the system in less than two minutes. To accomplish this, the present invention may utilize an assumption engine to speed up the registration process 800. For example if a user 40 indicates that they own a car, the system may automatically create template folders for car insurance, vehicle registration information, and vehicle service details. Similarly if a user 40 indicates that they own a property, the system may automatically create template folders for a mortgage, home owner's insurance, and all standard home utilities. Further, the assumption engine may auto-populate folder data fields using any personal information and data already available within the system. Alternatively, if a user 40 indicates a car is owned, the system may look up user specific personal information on third party information source computers 65 such as the Department of Motor Vehicles to automatically populate the make, model and vehicle identification data fields on the database 80.

File importing and exporting options may further ease the user experience. Fillable system-formatted spreadsheets may be made available for download and filled in at a user's leisure in order to make manual data input easier for users who wish to work locally. The reverse option may also be true, allowing a user to download all of their already stored data onto a spreadsheet for simple editing or as a means of securing a backup copy of their personal information.

Ownership of specific files may also be transferable. A parent or guardian may be called upon to manage the administrative accounts of a dependent child or elderly relative. Upon the child reaching the age of majority or the elderly user's ability to once again manage their own affairs, the administrator may be able to transfer ownership of specific personal information files to the appropriate new owner once the new owner has registered 800 with the system.

A file owner may request a quote by a variety of techniques. First, a user may affirmatively request 850 an immediate quote while logged into their specific user web page. Quotes immediately available from the service providers 60 will be displayed to the user 40, and quotes not immediately available from a service provider 60 will be forwarded along to the user 40 once transmitted by the service providers 60. Secondly, a user 40 may automatically request 850 a quote at a specifically configured time interval (e.g. weekly, monthly, annually, etc.). Thirdly, when a policy is coming up for termination or renewal the system may be preset to automatically request 850 a quote from the relevant service providers 60 within the time period for which the quote remains valid. Quotes, in many service provider industries, are typically valid for thirty days from the first offer. After a quote is accepted 860, the system may send an email to the user 40 with an embedded link to the service provider's 60 web site and auto-populate required personal information. Additionally, the system should be capable of hiding the user's specific contact information from service providers 60 until the user 40 elects to discuss a quote with a particular service provider 60.

A user 40 may be prompted to provide additional required information so that a greater number of quotes may be requested by the system on behalf of the user 40. Encouraging notifications or email messages may be displayed to the user 40 if they are missing only a small amount of information required to obtain another lowest possible quote through the present invention. The system may also be capable of facilitating user data input via color coded displays. One such example may designate required unsupplied data with red text, required supplied data with green text, and data not required with grey text.

Users 40 may also be notified of the account administration savings they have received while utilized the system and method of the present invention. This may be especially helpful if users 40 are reminded of their realized savings as the time for renewal of their subscription to the present invention approaches.

The system and method of the present invention may also be utilized by distributors and sub-distributors. Distributors may be motivated to assist in the growth of the system of the present invention via royalty incentives. Distributor functionality may incorporate displays of revenue generated, number of signups (original), number of signups (referred by original), number of non-converted (shows level of potential users), average revenue by user, average number of completed sections or fields, and the like. Similarly, royalty rewards may also be made available to individual users 40 based on their level of performance in referring friends to the system and method of the present invention.

A variety of additional user services may be available through the system. As with any service, referrals play a major role in growth of the system. Current users 40 may be asked to refer a friend, but maximum effectiveness may be achieved if the request is made just after the user 40 has received a new lowest quote possible from a service provider 60. Daily reminders may also be available for users 40 via their user specific web pages on the system, standard email, SMS message service, and any other notification method known within the art. Such reminders may include, but are not limited to, upcoming policy expiration dates, key dates for vehicle registration or service (such as registration dates or annual inspection dates), and the like. Additionally, users have the ability to add other key dates to their set of reminders, such as relevant dates for policies or services not yet added to the system of the present invention. These dates and reminders may be viewable in calendar format and may be further exportable to a spreadsheet or to calendaring software such as the Outlook program available from Microsoft®.

The present invention may further incorporate tax return functionality wherein a user's stored tax information data may auto-populate all required fields on the web site of a tax return service provider 60. Yet further, a savings calculator may be viewable by a user 40 so as to review their accumulated savings to date.

The present invention may incorporate several forms of messaging, which may include but are not limited to on screen messages while a user 40 is logged into the system, email notifications, Short Message Service (SMS) messages, and the like. Users 40, service providers 60, and distributors may all be allowed a definable level of functional messaging capability. In this manner, users 40 may communicate with their friends and both service providers 60 and distributors may contact their consumer groups with urgent or updated business information.

The data stored on the server database 80 may be protected from unauthorized access in any ways known in the art, preferably including password protection and encryption to at least a standard set by national or international standards bodies. Such protection and security measures may provide a high level of encryption and allow only authenticated user access to personal information. Arrangements may also be made to pay a registration fee on registering with the database 80 of the system.

While the above description contains much specificity, these should not be construed as limitations on the scope of any embodiment, but as exemplifications of the presently preferred embodiments thereof. Many other ramifications and variations are possible within the teachings of the various embodiments.

Thus the scope of the invention should be determined by the appended claims and their legal equivalents, and not by the examples given.

What is claimed is:

1. A system for storing and transacting personal information of a user, comprising:
a communication network;
a server computer comprising a database for storing said personal information from a plurality of users including said user wherein said server computer and said database are communicatively coupled to said communication network;
a user computer communicatively coupled to said communication network providing communication between said user computer and said server computer, wherein said personal information is inputted and communicated on a once-only basis into said database to eliminate input repetition of said personal information; and
a plurality of service provider computers communicatively coupled to said communication network providing selective communication between said plurality of service provider computers and said database, wherein said server computer queries said plurality of service provider computers for service provider quotes;
wherein a lowest possible quote is determined by comparing said quotes received from said plurality of service provider computers.

2. The system for storing and transacting personal information of claim 1, wherein said system is capable of querying for said lowest possible quote within a plurality of respective service provider fields.

3. The system for storing and transacting personal information of claim 2, wherein said system queries for a plurality of respective lowest possible quotes across said plurality of respective service provider fields.

4. The system for storing and transacting personal information of claim 3, wherein said plurality of customer service fields comprises at least three service provider fields.

5. The system for storing and transacting personal information of claim 3, wherein said system locates additional personal information via third party information source computers and adds said additional personal information to said database.

6. The system for storing and transacting personal information of claim 3, wherein said system verifies said personal information stored on said database by cross checking data on third party information source computers.

7. The system for storing and transacting personal information of claim 3, wherein said system instantaneously queries for said lowest possible quote from said plurality of service provider computers upon a request by said user.

8. The system for storing and transacting personal information of claim 3, wherein said system automatically searches for said lowest possible quote from said plurality of service provider computers on a periodic basis.

9. The system for storing and transacting personal information of claim 3, wherein said system automatically searches for said lowest possible quote from said plurality of service provider computers at a specified time period prior to account renewal or expiration dates of said user.

10. The system for storing and transacting personal information of claim 3, wherein said system communicates updates made in said personal information of said database to said plurality of service provider computers via said communication network.

11. A method of storing and transacting personal information of a user, comprising the steps of:
communicating said personal information from a user computer to a database of a server computer on a once-only basis to eliminate input repetition of said personal information, wherein said user computer and said server computer are communicatively coupled over a communication network;
storing said personal information on said database of said server computer;
selectively transmitting said personal information from said database to a plurality of service provider computers communicatively coupled to said communication network, wherein said system queries for service provider quotes from said plurality of service provider computers; and
receiving said quotes from said plurality of service provider computers to said server computer;
wherein a lowest possible quote is determined by comparing said quotes received from said plurality of service provider computers.

12. The method of storing and transacting personal information of claim 11, wherein said step of transmitting said personal information and querying for said quotes is capable of querying for said quotes within a plurality of respective service provider fields.

13. The method of storing and transacting personal information of claim 12, wherein said step of transmitting said personal information and querying for said quotes queries for a plurality of lowest possible quotes across said plurality of respective service provider fields.

14. The method of storing and transacting personal information of claim 13, wherein said plurality of customer service fields comprises at least three service provider fields.

15. The method of storing and transacting personal information of claim 13, further comprising the step of locating additional personal information via third party information source computers and adding said additional personal information to said database.

16. The method of storing and transacting personal information of claim 13, further comprising the step of verifying said personal information stored on said database by cross checking data on third party information source computers.

17. The method of storing and transacting personal information of claim 13, wherein said step of transmitting said personal information and querying said plurality of service provider computers is instantaneously performed after a request by said user.

18. The method of storing and transacting personal information of claim 13, wherein said step of transmitting said personal information and querying said plurality of service provider computers is performed on a periodic basis.

19. The method of storing and transacting personal information of claim 13, wherein said step of transmitting said personal information and querying said plurality of service provider computers is performed at a specified time period prior to account renewal or expiration dates of said user.

20. The method of storing and transacting personal information of claim 13, further comprising the step of transmitting updates made in said personal information of said database to said plurality of service provider computers via said communication network.
